(19) United States
(12) Patent Application Publication
(10) Pub. No.: US 2007/0214835 A1
(43) Pub. Date: Sep. 20, 2007

(54) Glass gob shaping apparatus, process for the production of glass gobs and process for the production of optical element

(75) Inventors: Atsushii Uezaki, Tokyo (JP); Yoshinori Iguchi, Tokyo (JP)

Correspondence Address: NIXON & VANDERHYE, PC, 901 NORTH GLEBE ROAD, 11TH FLOOR, ARLINGTON, VA, 22203, US

(73) Assignee: HOYA CORPORATION, Tokyo (JP)

(21) Appl. No.: 11/712,552

(22) Filed: Mar. 1, 2007

(30) Foreign Application Priority Data
Mar. 14, 2006 (JP) 2006-068951

(51) Int. Cl. C03B 23/04; C03B 9/00; C03B 23/18

(52) U.S. Cl. 65/82; 65/261

(57) ABSTRACT

A glass gob shaping apparatus for shaping glass into glass gobs with a plurality of shaping molds while causing glass to stably float, in which molten glass is supplied to shaping molds and shaped into glass gobs while causing glass to float by ejecting gas from the shaping molds and applying gas pressure, the apparatus including (1) an apparatus having a plurality of shaping molds, a gas supply mechanism for supplying said gas and a gas flow passage for supplying gas from the gas supply mechanism to the shaping molds, said gas flow passage having a buffer mechanism for suppressing the variance of gas ejection amounts in shaping molds during shaping of the glass which variance is caused by a pressure variance in gas ejection ports of other shaping molds and (2) an apparatus having a plurality of shaping molds and gas supply mechanisms for supplying said gas, said gas supply mechanisms being independently provided in a manner that one single gas supply mechanism corresponds to one shaping mold.

### TECHNICAL FIELD

The present invention relates to a glass gob shaping apparatus, a process for the production of glass gobs and a process for the production of an optical element. More specifically, the present invention relates to a glass gob shaping apparatus and a glass gob production process for shaping glass into glass gobs with a plurality of molds while causing the glass to float in a stabilized state and a process for the production of an optical element by precision press-molding of a glass gob with the above apparatus or a glass gob produced by the above process.

### TECHNICAL BACKGROUND

There is known a method in which a molten glass is caused to flow out, a flowing glass is received with a shaping mold and the glass is shaped into a precision press molding preform while the glass is caused to float. This method can prevent the formation of a wrinkle on the preform surface and the damage of the glass called “cracking” during the shaping.

The above method is described in JP-A-2003-20248.

In the above method, a molten glass that is continuously flowing out is shaped into glass gobs one after another, so that it is desirable to use a plurality of shaping molds. Such shaping molds can be used repeatedly for receiving molten glass after glass shaped products are taken out upon completion of the shaping, so that it is preferred to use the shaping molds in circulation. The above method implies that the shaping constantly takes place while glass is caused to float above two or more shaping molds.

In the above apparatus, one single gas supply mechanism is used as a gas supply source and a gas supplied from the supply source is divided to each shaping mold.

Of the above plurality of shaping molds, some shaping molds are working to shape glass into glass gobs and some shaping molds are in an empty state after shaped glass is taken out. In a mold working to shaping a glass into a glass gob while causing the glass to float, therefore, the pressure of the ejected gas increases due to the floating of the glass and becomes higher than the gas pressure in an empty shaping mold. Further, as the floating state of the glass varies, the pressure of the ejected gas in such a shaping mold varies. When the gas pressure varies among the shaping molds as described above, such a variance affects the gas pressures in other shaping molds and the floating of the glass in each shaping mold is destabilized.

For example, when the floating gas pressure is insufficient, part of the glass comes in contact with a shaping mold and such a portion is cooled to excess to generate a non-uniform strain, so that the glass is liable to break. Further, when a glass is shaped into a spherical form by moving the glass up and down, the upward and downward movement may not be smoothly performed or a gas ejection port may be clogged. When the floating gas pressure is in excess, there is caused a problem that the glass is not stabilized in a shaping mold and hence cannot be shaped into a desired form.

### DISCLOSURE OF THE INVENTION

### Problems to be Solved by the Invention

Under the circumstances, it is an object of the present invention to provide a glass gob shaping apparatus for shaping glass into glass gobs with a plurality of shaping molds while causing the glass to float in a stable state and a process for the production of glass gobs.

It is also another object of the present invention to provide a process for the production of an optical element by precision press-molding a glass gob shaped with the above apparatus or a glass gob produced by the above process.

### Means to Solve the Problems

The present inventors have made diligent studies for achieving the above objects and as a result found that the objects can be achieved by a specific glass gob shaping apparatus or a specific process for producing glass gobs. On the basis of these findings, the present invention has been completed.

That is, the present invention provides;

(1) a glass gob shaping apparatus for supplying molten glass to shaping molds and shaping said glass into glass gobs while causing glass to float by ejecting gas from the shaping molds and applying gas pressure, the apparatus comprising a plurality of shaping molds, a gas supply mechanism for supplying said gas and a gas flow passage for supplying gas from the gas supply mechanism to the shaping molds, said gas flow passage having a buffer mechanism for suppressing the variance of gas ejection amounts in shaping molds during shaping of the glass which variance is caused by a pressure variance in gas ejection ports of other shaping molds,

(2) a glass gob shaping apparatus as recited in the above (1), wherein the gas flow passage has a manifold portion for distributing gas supplied from one single gas supply mechanism to the shaping molds and as the buffer mechanism, check valves are provided in gas flow passage between said manifold portion and the shaping molds (to be referred to as “glass gob shaping apparatus 1” hereinafter),

(3) a glass gob shaping apparatus as recited in the above (1), wherein the gas flow passage has a manifold portion for distributing gas supplied from one single gas supply mechanism to the shaping molds and as the buffer mechanism, gas flow regulating mechanisms are provided in gas flow passage between said manifold portion and the shaping molds (to be referred to as “glass gob shaping apparatus 2” hereinafter),

(4) a glass gob shaping apparatus as recited in the above (2) or (3), wherein the shaping molds have gas ejection portions formed of a porous material,

(5) A glass gob shaping apparatus as recited in the above (1), wherein the gas flow passage has a manifold portion for distributing gas supplied from one single gas supply mechanism to the shaping molds and a porous material is used as a material constituting gas ejection portions of the shaping molds for the buffer mechanism of said gas flow passage (to be referred to as “glass gob shaping apparatus 3” hereinafter),

(6) a glass gob shaping apparatus for supplying a molten glass to shaping molds and shaping said glass into glass gobs while causing glass to float by ejecting gas from the shaping molds and applying gas pressure, the apparatus comprising a plurality of shaping molds and gas supply mechanisms for supplying said gas, said gas supply mechanisms being independently provided in a manner that one single gas supply mechanism corresponds to one shaping mold (to be referred to as “glass gob shaping apparatus 4” hereinafter),

(7) A glass gob shaping apparatus as recited in any one of the above (1) to (6), which has a shaping mold transfer mechanism for transferring the plurality of shaping molds in circulation,

(8) a process for the production of glass gobs by supplying a molten glass to shaping molds and shaping said glass into glass gobs while causing glass to float by ejecting gas from the shaping molds and applying gas pressure,

the process comprising simultaneously shaping glass into glass gobs above a plurality of the shaping molds while a gas supply source for supplying said gas is used in common and return flows of the gas are suppressed between a gas manifold portion existing between said gas supply source and the shaping molds and the shaping molds (to be referred to as “glass gob production process 1” hereinafter),

(9) a process for the production of glass gobs by supplying a molten glass to shaping molds and shaping said glass into glass gobs while causing glass to float by ejecting gas from the shaping molds and applying gas pressure,

the process comprising simultaneously shaping glass into glass gobs above a plurality of the shaping molds while a gas supply source for supplying said gas is used in common and gas flow rates are adjusted between a gas manifold portion existing between said gas supply source and the shaping molds and the shaping molds (to be referred to as “glass gob production process 2” hereinafter),

(10) a process for the production of glass gobs by supplying a molten glass to shaping molds and shaping said glass into glass gobs while causing glass to float by ejecting gas from the shaping molds and applying gas pressure,

the process comprising supplying a gas to each shaping mold from a common gas supply source through branched gas flow passages to eject gas from gas ejection portions formed of a porous material in the shaping molds and concurrently shaping glass into the glass gobs above a plurality of the shaping molds (to be referred to as “glass gob production process 3” hereinafter),

(11) a process for the production of glass gobs by supplying a molten glass to shaping molds and shaping said glass into glass gobs while causing glass to float by ejecting gas from the shaping molds and applying gas pressure,

the process comprising shaping glass into glass gobs above a plurality of the shaping molds while the gas is supplied to the plurality of the shaping molds from independent gas supply sources (to be referred to as “glass gob production process 4” hereinafter), and

(12) a process for the production of an optical element, which comprises heating a glass gob shaped with the apparatus recited in any one of the above (1) to (7) or a glass gob produced by the process recited in any one of the above (8) to (11) and precision press-molding the glass gob.

### BRIEF DESCRIPTION OF DRAWINGS

FIG. 1 is a partial schematic drawing of one example of the glass gob shaping apparatus 1 of the present invention, in which (a) shows a plan view and (b) shows a side view.

FIG. 2 is a partial schematic drawing of one example of a gas manifold portion and its vicinities in the glass gob shaping apparatus 1 of the present invention.

FIG. 3 is a partial schematic drawing of one example of the glass gob shaping apparatus 3 of the present invention, in which (a) shows a plan view and (b) shows a side view.

FIG. 4 is a schematic drawing of a porous material mold of a shaping mold in the glass gob shaping apparatus 3 of the present invention.

FIG. 5 is a schematic side view of one example of the glass gob shaping apparatus 4 of the present invention.

### EFFECT OF THE INVENTION

According to the present invention, there can be provided a glass gob shaping apparatus and a glass gob production process for shaping glass into glass gobs with a plurality of shaping molds while glass is caused to float and a process for the production of an optical element by precision press-molding of a glass gob shaped with the above apparatus or a glass gob shaped by the above process.

### PREFERRED EMBODIMENTS OF THE INVENTION

First, the glass gob shaping apparatus of the present invention will be explained.

The glass gob shaping apparatus of the present invention is largely classified into two embodiments. The first embodiment is a glass gob shaping apparatus for supplying molten glass to shaping mold and shaping glass into glass gobs while causing glass to float by ejecting gas from the shaping molds and applying gas pressure,

the apparatus comprising a plurality of shaping molds, a gas supply mechanism for supplying said gas and a gas flow passage for supplying gas from the gas supply mechanism to the shaping molds and said gas flow passage having a buffer mechanism for suppressing the variance of gas ejection amounts in shaping molds during shaping of the glass which variance is caused by a pressure variance in gas ejection ports of other shaping molds.

The glass gob shaping apparatus in the above first embodiment is further classified into the following glass gob shaping apparatus 1, glass gob shaping apparatus 2 and glass gob shaping apparatus 3 on the basis of types of the buffer mechanism in the above gas flow passage.

Further, a glass gob shaping apparatus in the second embodiment is a glass gob shaping apparatus 4 to be explained later.

### [Glass Gob Shaping Apparatus 1]

The glass gob shaping apparatus 1 is a shaping apparatus according to the above embodiment 1, in which the gas flow passage has a manifold portion for distributing gas from one single gas supply mechanism to the shaping molds and check valves are provided between the above manifold portion and the shaping molds as a buffer mechanism.

In the above glass gob shaping apparatus 1, a gas supply source for a plurality of the shaping molds is used in common and a gas supplied from one single gas supply mechanism is distributed through a manifold portion and introduced to the shaping molds through check valves. Therefore, even when the pressure of gas ejected in a certain individual shaping mold varies, the influence of the variance on the pressure of gas ejected from any other shaping mold can be prevented by means of a check value provided between the individual shaping mold and the manifold portion.

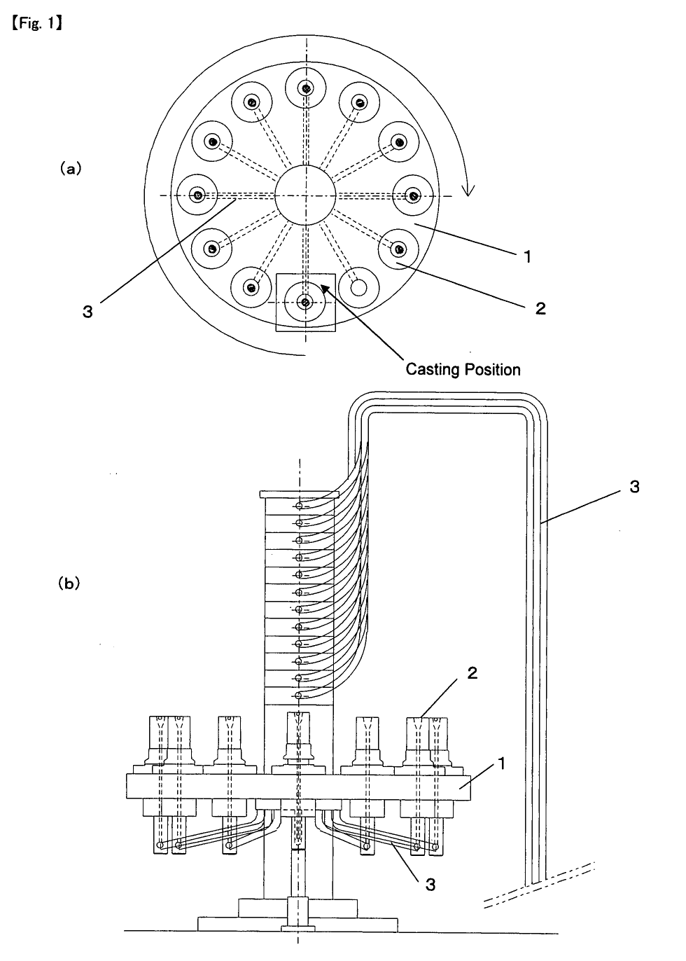

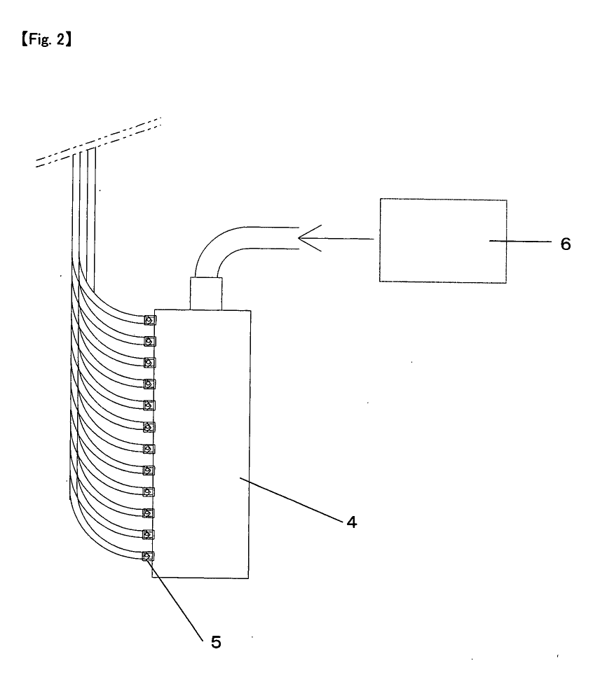

FIG. 1 is a partial schematic drawing of one example of the glass gob shaping apparatus 1 of the present invention, in which (a) shows a plan view and (b) shows a side view. FIG. 2 is a partial schematic drawing of a gas manifold portion and its vicinities in the glass gob shaping apparatus 1 of the present invention.

In FIGS. 1 and 2, numeral 1 indicates a turn table that index-turns in the direction of an arrow, 2 indicates a shaping mold, 3 indicates a gas flow passage, 4 indicates a gas manifold portion, 5 indicates a check valve and 6 indicates a gas supply mechanism.

### [Glass Gob Shaping Apparatus 2]

The glass gob shaping apparatus 2 is a shaping apparatus according to the above first embodiment, in which the gas flow passage has a manifold portion for distributing gas supplied from one single gas supply mechanism to the shaping molds and as the buffer mechanism, gas flow regulating mechanisms are provided in gas flow passage between said manifold portion and the shaping molds. That is, the gas flow regulating mechanisms are provided in place of the check valves in the above glass gob shaping apparatus 1.

In the above glass gob shaping apparatus 2, one single gas supply source for a plurality of the shaping molds is used in common and a gas supplied from one single gas supply mechanism is distributed through a manifold portion and introduced to the shaping molds through gas flow regulating mechanisms. In this case, a high pressure is kept on the inlet sides of the gas flow regulating mechanisms and the rates of gas flows to the glass gob shaping molds are constricted with the above gas flow regulating mechanisms. Therefore, when a back pressure works on the outlet side of each gas flow regulating mechanism, the variance of the flow rate is suppressed so that the variance is small and that the flow rate of gas to any other glass gob shaping mold is not affected.

When the flow regulating mechanisms are adjusted, preferably, the constrictions of the gas flow regulating mechanisms are adjusted while the flow rates on the outlet sides are measured in a gas-supplied state, such that the flow rate of gas ejected from glass gob shaping portions become equal.

### [Glass Gob Shaping Apparatus 3]

The glass gob shaping apparatus 3 is a shaping apparatus according to the above first embodiment, in which the gas flow passage has a manifold portion for distributing gas supplied from one single gas supply mechanism to the shaping molds and a porous material is used as a material constituting gas ejection portions of the shaping molds for the buffer mechanism of the above gas flow passage.

In the above glass gob shaping apparatus 3, the porous material constituting the gas ejection portions of the shaping molds performs the function of the check valves in the above glass gob shaping apparatus 1 or the gas flow regulating mechanisms in the glass gob shaping apparatus 2. The porous material functions as a resistance to the gas flow. When a floating pressure is applied to the glass with the gas ejected from the porous material, a counteraction to the floating pressure works as a resistance to the gas flow. In this case, the resistance based on the counteraction by the floating pressure is fairly small as compared with the resistance by the porous material, so that the influence of variance of the above counteraction on the rate of gas ejected can be minimized to cause no detrimental effect on the shaping in other shaping molds. For increasing the above effect of the porous material, preferably, the porous material is produced from a refractory material such as stainless steel and has a porosity of 30% or less and an average pore diameter of 20 μm or less.

In addition, the above shaping apparatus 1 and the above shaping apparatus 3 can be combined, or the above shaping apparatus 2 and the above shaping apparatus 3 can be combined. By such a combination, glass can be caused to float more stably.

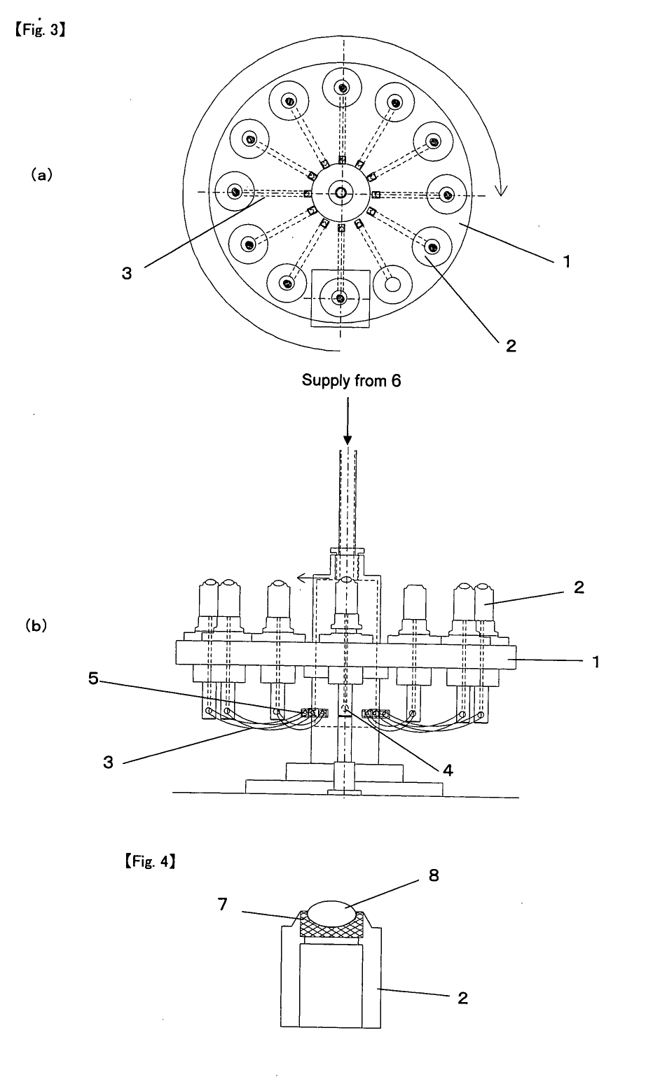

FIG. 3 is a partial schematic drawing of one example of the glass gob shaping apparatus 3 of the present invention, in which (a) shows a plan view and (b) shows a side view. FIG. 4 is a schematic drawing of a porous material mold of a shaping mold in the glass gob shaping apparatus 3 of the present invention. Numeral 7 indicates a porous material mold, 8 indicates a glass gob and other numerals are as used with regard to the above shaping apparatus 1.

### [Glass Gob Shaping Apparatus 4]

The glass gob shaping apparatus 4 is a glass gob shaping apparatus for supplying a molten glass to shaping molds and shaping said glass into glass gobs while causing glass to float by ejecting gas from the shaping molds and applying gas pressure,

the apparatus comprising a plurality of shaping molds and gas supply mechanisms for supplying said gas, said gas supply mechanisms being independently provided in a manner that one single gas supply mechanism corresponds to one shaping mold.

In the above glass gob shaping apparatus 4, gas supply sources are divided for every shaping mold in a manner that one single gas supply source is for one shaping mold, and gas is supplied from one single gas supply unit to one shaping mold and gas is supplied from another supply unit to another shaping mold. In the above structure, gas is supplied independently to every shaping mold, so that the variance of a gas pressure in one shaping mold no longer has an influence on the gas pressure in another shaping mold.

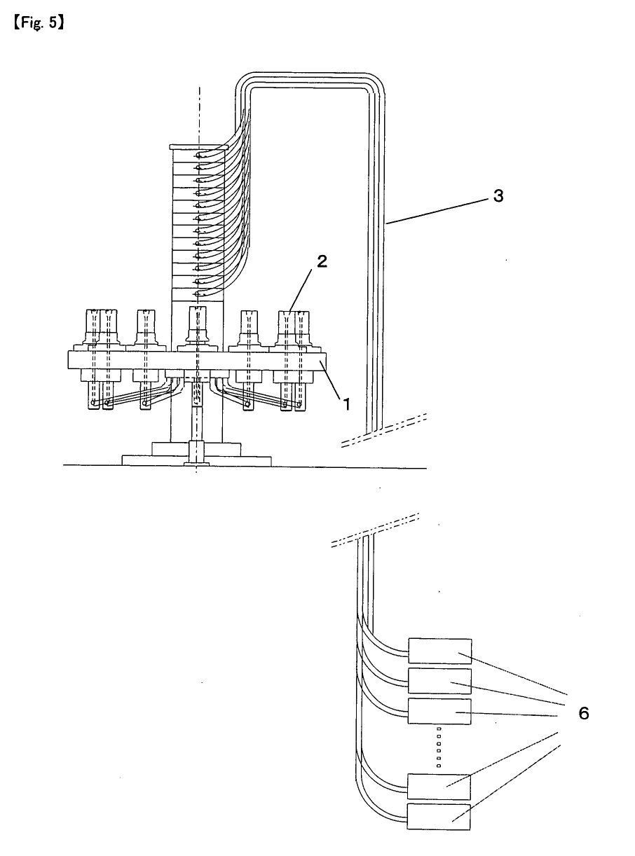

FIG. 5 is a schematic side view of one example of the glass gob shaping apparatus 4 of the present invention, in which numerals are as used with regard to the above glass gob shaping apparatus 1.

In the above glass gob shaping apparatuses 1, 2 and 3, the gas supply mechanism can be used in common, so that the entire apparatus can be produced at a low cost as compared with the above glass gob shaping apparatus 4. Further, the glass gob shaping apparatuses 1, 2 and 3 are advantageous in view of energy saving and less occupation of a space. Since glass gobs are shaped while a plurality of shaping molds are transferred, arranging pipes for supplying gas from a plurality of gas supply mechanisms to shaping molds like the shaping apparatus 4 makes the apparatus complicated. In contrast, arranging one pipe from the gas supply mechanism to a manifold portion is sufficient in the shaping apparatuses 1 to 3, so that the designing of such apparatuses is easier.

In all of the above shaping apparatuses 1 to 4, a molten glass that is continuously flowing out can be shaped into glass gobs one after another by providing a shaping mold transfer unit for transferring a plurality of shaping molds in circulation. For example, shaping molds are revolved on the same circumference synchronously by means of a turn table and a turning unit for index-turning the above turn table to shaping glass gobs one after another. This point is common to the above embodiments. This common point will be explained below.

First, glass raw materials mixed so as to obtain an intended glass composition are introduced into a melting vessel, heated, melted, refined and homogenized to obtain a molten glass. The molten glass is introduced from a pipe attached to the melting furnace at a constant flow rate at a temperature at which the glass does not devitrify, and it is caused to continuously flow out from a pipe outlet. For obtaining glass shaped products having a constant mass, the flow rate of the molten glass that flows out per a unit time period is maintained at a constant level by controlling the temperature of the pipe and the like.

A turn table with a plurality of shaping molds to be used for shaping on it is provided below the pipe. The shaping molds are arranged at regular intervals on the circumference centering around the rotation axis of the turn table, and the table is index-turned to transfer the shaping molds one after another to predetermined stop positions corresponding to the number of the shaping molds while synchronizing the shaping molds.

One of the above stop positions is assigned to a casting position, and it is ensured that the pipe outlet is positioned above a shaping mold that is at a stop in the casting position.

At the casting position, molten glass is supplied to the shaping mold, and the shaping mold supplied with the molten glass is transferred out of the casting position due to the turn of the table, and a shaping mold in an empty state is transferred into the casting position. While the shaping mold with the molten glass on it is repeatedly moved and stopped, the molten glass is shaped into a glass gob above the shaping mold.

The method for shaping a molten glass into a glass gob includes several shaping methods. The first shaping method is a method in which gas is ejected from the shaping mold to apply an upward gas pressure to the glass to shape the glass while the glass is caused to float above the shaping mold. By this method, a glass shaped product having a surface formed of a free surface can be obtained. In the first shaping method, it is desirable to constitute the gas ejection port of the shaping mold from the porous material. A gas pressure is applied to the reverse surface of the porous material, whereby the gas passes through fine spaces of the porous material to be ejected through fine pores that exist on the porous material surface uniformly and in great numbers. By the above gas ejection, a floating gas pressure can be applied to the entire lower surface of the glass.

In the second shaping method, gas is ejected from a shaping mold to apply an upward gas pressure to glass as well. In this method, the shaping mold is imparted with a shaping mold form that is a form having a concave portion whose cross-sectional form in the horizontal direction is circular and whose circular form increases upwardly, preferably, a form having diameters in circles whose increase ratio increases from bottom to top (e.g., a trumpet-shaped form). The ejection port of the above gas is formed in a bottom portion of a trumpet-shaped concave portion. When glass moves down toward the bottom of the concave portion, it falls against an upward strong gas pressure to move upward, and when it moves upward, the above gas pressure decreases and it moves downward. The glass so repeats upward and downward movements in the concave portion. The glass rotates at random due to these upward and downward movements to be shaped into a spherical form. The above upward and downward movements cause the variance of gas pressures in other shaping molds, while the variance of the gas pressures can be suppressed by means of the buffer mechanism.

At a stage when the glass gob is cooled to such an extent that it is no more deformed by a force exerted by taking it out, the glass gob is take out. The glass gob taken out of the shaping mold is cooled to room temperature by annealing.

The process for the production of a glass gob, provided by the present invention, will be explained below.

The process for the production of a glass gob, provided by the present invention, includes four embodiments or the following glass gob production processes 1, 2, 3 and 4.

### [Glass Gob Production Process 1]

The glass gob production process 1 is a process for the production of glass gobs by supplying a molten glass to shaping molds and shaping said glass into glass gobs while causing glass to float by ejecting gas from the shaping molds and applying gas pressure,

the process comprising simultaneously shaping glass into glass gobs above a plurality of the shaping molds while a gas supply source for supplying said gas is used in common and return flows of the gas are suppressed between a gas manifold portion existing between said gas supply source and the shaping molds and the shaping molds.

The above glass gob production process 1 corresponds to a method of use of the above glass gob shaping apparatus 1.

### [Glass Gob Production Process 2]

The glass gob production process 2 is a process for the production of glass gobs by supplying a molten glass to shaping molds and shaping said glass into glass gobs while causing glass to float by ejecting gas from the shaping molds and applying gas pressure,

the process comprising simultaneously shaping glass into glass gobs above a plurality of the shaping molds while a gas supply source for supplying said gas is used in common and gas flow rates are adjusted between a gas manifold portion existing between said gas supply source and the shaping molds and the shaping molds.

The glass gob production process 2 corresponds to a method of use of the above glass gob shaping apparatus 2.

### [Glass Gob Production Process 3]

The glass gob production process 3 is a process for the production of glass gobs by supplying a molten glass to shaping molds and shaping said glass into glass gobs while causing glass to float by ejecting gas from the shaping molds and applying gas pressure,

the process comprising supplying a gas to each shaping mold from a common gas supply source through branched gas flow passages to eject gas from gas ejection portions formed of a porous material in the shaping molds and concurrently shaping glass into the glass gobs above a plurality of the shaping molds.

The glass gob production process 3 corresponds to a method of use of the above glass gob shaping apparatus 3.

### [Glass Gob Production Process 4]

The glass gob production process 4 is a process for the production of glass gobs by supplying a molten glass to shaping molds and shaping said glass into glass gobs while causing glass to float by ejecting gas from the shaping molds and applying gas pressure,

the process comprising shaping glass into glass gobs above a plurality of the shaping molds while the gas is supplied to the plurality of the shaping molds from independent gas supply sources.

The glass gob production process 4 corresponds to a method of use of the above glass gob shaping apparatus 4.

According to the process for the production of a glass gob, provided by the present invention, glass can be caused to stably float above shaping molds, so that glass gobs having a desired form can be shaped. Further, the above process can ensure that the glass that is being shaped is free from being in contact with a shaping mold for a long period of time, so that the glass can be uniformly cooled. As a result, there can be also overcome a problem that an asymmetric strain is built up in a glass gob to decrease the mechanical strength thereof.

The process for the production of an optical element will be explained below.

### [Process for the Production of Optical Element]

The process for the production of an optical element, provided by the present invention, comprises heating a glass gob shaped with the above optical glass shaping apparatus or a glass gob produced by the above glass gob production process and precision press-molding the same.

The above process is based on the premise that a glass gob produced with the above apparatus or a glass gob produced by the above process is used as a precision press-molding preform. A shaped glass gob is washed as required and is surface-coated with a carbon-containing film or the like. The film works to improve the lubricity between a glass and a press mold to ensure that the glass fully spreads in the press mold during press-molding.

Then, the glass gob is introduced into a press mold, the glass gob and the press mold are heated together and the glass gob is precision press-molded to shape the entire glass shape and transfer the form of molding surface of the press mold to the glass. And, the glass and the press mold are cooled in a state where the glass is under pressure of the press mold, and after the temperature reaches a temperature at which a press-molded product is not deformed, the press-molded product is taken out of the press mold. When a carbon-containing film is coated on the glass gob, the film is removed by an oxidation method or the like, to give an optical element. A precision press-molded product may be subjected to processing such as processing for centering and edging as required. Alternatively, a separately heated glass gob may be introduced to a pre-heated press mold to carry out the precision press-molding thereof. For the above precision press-molding, a known method can be employed. For example, there can be employed a method in which a known press mold such as a press mold made of SiC having a molding surface with a carbon film formed thereon or a press mold made of WC having a molding surface with a noble metal alloy formed thereon is provided and in an atmosphere containing a gas mixture of nitrogen with hydrogen, the press mold is heated and precision press-molding is carried out.

In the above manner, optical elements such as various lenses including an aspherical lens and a spherical lens and a prism are produced. An optical multi-layered film such as an anti-reflection film or the like may be formed on the thus-obtained optical element as required.

According to the process for the production of an optical element, optical elements can be stably mass-produced since glass gobs to be used as preforms can be stably supplied in the present invention.

### EXAMPLES

The present invention will be explained more in detail hereinafter with reference to Examples, while the present invention shall not be limited by these Examples.

### Example 1

Twelve shaping molds are arranged at regular intervals on a turn table that is to make an index-turn, and a concave portion formed of a porous material is provided in an upper surface of each shaping mold. The concave portion each has a form of rotational symmetry and is processed so as to have a form fit to the lower surface of an intended glass gob. Concerning the specification of the porous material, its material is SUS316 and it has a porosity of 20% and an average pore diameter of 8 μm.

In an inside under the reverse surface of the porous material in each shaping mold, a space is provided, and a gas flow passage for supplying gas is connected to the space through a fixing tool with which the shaping mold is fixed to the turn table. A tube for supplying gas to the gas flow passage is attached to a lower portion of the above fixing tool, and other ends of such tubes converge in the rotating shaft of the turn table. The tubes that converge in the rotating shaft join one another in a manifold portion through check valves and each gas flow passage joins one main tube. The main tube is divided through a rotatable connector to a portion that rotates together with the table and a portion that does not rotate. The portion that rotates is connected to the manifold portion and the portion that does not rotate is connected to a compressor as a gas source that is placed outside the rotating shaft. The above connector is to be a connector that leaks no gas during the rotation of the main tube. The compressor has a filter attached thereto since it is taken into account that clean gas is supplied to each shaping mold.

In the above manner, gas supplied from one single gas supply source is supplied to the manifold portion through the main tube and divided to as many branch tubes as the shaping molds, and then gas is supplied to each check valve, to each fixing tool and then to each shaping mold and is ejected through the porous material of each shaping mold. The check valves are all of one type and the same and the number thereof is the same as the number of the shaping molds. Further, the branch tubes are so arranged that they are equal in caliber and length.

The thus-adjusted glass gob shaping apparatus is arranged beneath a pipe from which a molten glass is to continuously flow out. And, it is ensured that the molten glass is supplied to a shaping mold in a specific stop position (to be referred to as “casting position”) out of stop positions of the shaping molds. Specifically, the shaping mold at a stop in the casting position is moved upward until it comes near to the outlet of the pipe, to support the lower end of the molten glass that is flowing out, a narrow portion is formed between the pipe outlet side and the shaping mold side of the molten glass that is flowing out, then, the shaping mold is rapidly moved downward to separate the molten glass at the narrow portion and a molten glass having a predetermined weight is hence obtained on the shaping mold.

Gas supplied from the gas source (compressor), which is being ejected from the above concave portion, exerts an upward gas pressure on the above glass to cause it to float. The glass is formed into a glass gob having a surface formed of a free surface while it is cooled in a floating state. After cooled, the glass gob is taken out of the shaping mold.

The above operation is carried out while the turn table is index-turned, so that the molten glass that continuously flows out is formed into glass gobs, which are formed one after another on/above the shaping molds placed on the table. A shaping mold in an empty state after a glass gob is taken out is transferred to the casting position to receive a subsequent molten glass.

According to the above apparatus and process, shaping molds in an empty state and shaping molds with floating glass are co-present, the floating gas is supplied from the common gas supply source to these shaping molds and under these circumstances, the influences of gas ejection amounts in shaping molds on gas ejection amounts of other shaping molds can be prevented, so that glass can be caused to stably float above the shaping molds and shaped into glass gobs.

As a result, glass gobs shaped with these shaping molds were uniform in form and each of them was also uniformly cooled, so that the thus-obtained glass gobs were free from breaking.

Then, the check valves were removed to directly connect the manifold portion and the shaping molds, and similar shaping was carried out. In this case, convexoconcave forms of the porous materials of the molds were transferred to glass bottom surfaces. The cause thereof is as follows. When glass falls in a mold, the glass works as a resistance, more gas flows into molds with no glass in them, the flow amount of gas in the mold with glass in it decreases and the floating state of glass above the mold is destabilized. Further, when the floating state of glass above a mold is unstable, the glass may break.

Then, the porous material was removed, a member having a plurality of narrow through holes was attached to the bottom of concave portion of each mold instead and shaping was carried out while gas was ejected from the through holes. In this case, the check valves were removed. As a result, the floating of the glass was destabilized, the glass and the concave portion of each shaping mold came in contact with each other constantly and the glass was non-uniformly cooled, so that there was caused a problem that some of the thus-obtained glass gobs broke. Further, while each concave portion was so made as to have a form of rotational symmetry, the glass gobs came to have a form of extraordinary non-rotational symmetry.

### Example 2

Then, all of the fixing tools of the glass gob shaping apparatus explained in Example 1 were removed, and all of the shaping molds were replaced with new ones. Each of the newly fixed shaping molds had a concave portion having a trumpet-shaped form of rotational symmetry, its cross-sectional form perpendicular to the axis of the rotational symmetry was circular and the diameter in circle increased from bottom to top. The bottom of the concave portion of each shaping mold had one gas ejection port connected to the gas flow passage of the fixing tool, and it was ensured that gas was ejected upward from it.

Except for the above shaping molds substituted here, the apparatus had an apparatus constitution having as many check valves as those of the shaping apparatus explained in Example 1.

And, a molten glass is dropped from the outlet of the pipe to the periphery of concave portion of a shaping mold at stop in the casting position and a molten glass drop received on the above periphery is introduced into the concave portion. The glass in the concave portion flows toward the bottom portion thereof and as it flows down, it undergoes the high pressure of ejected gas and moves upward. As the glass moves upward, the gas pressure decreases and the glass again moves downward. When the glass repeats these movements, the glass revolves to be shaped into a spherical form.

A glass gob shaped in a spherical form is taken out of the shaping mold, and the shaping mold in an empty state is transferred to the casting position. By repeating the above operation, spherical glass gobs are produced one after another from a molten glass that continuously drops down.

According to the apparatus and process of this Example, glass can be caused to stably float and revolved in each shaping mold, so that spherical glass gobs can be stably produced.

In an apparatus that has check valves and that permits the replacement of shaping molds using fixing tools like the apparatus of Examples 1 and 2, shaping molds can be selected depending upon the specification of intended glass gobs. And, even when shaping molds having no gas ejection ports formed of the porous material (having the above substitutes for the gas ejection ports formed of the porous material) are attached to the apparatus, glass can be caused to stably float and shaped into glass gobs.

Then, shaping was carried out with the apparatus of the above Examples from which the check valves had been removed, the sphericity of glass gobs decreased.

### Example 3

Those glass gobs shaped by the use of the check valves in Examples 1 and 2 were provided as precision press-molding preforms, and the preforms were precision press-molded to produce various lenses such as aspherical lenses and spherical lenses and prisms. The preforms were all uniform in form, so that the intended optical elements could be stably produced.

### INDUSTRIAL UTILITY

By the use of the glass gob shaping apparatus and glass gob production process of the present invention, glass can be stably shaped into glass gobs with a plurality of shaping molds while the glass is caused to float in a stable state. The thus-obtained glass gobs can give various optical elements by the precision press-molding.

1. A glass gob shaping apparatus for supplying molten glass to shaping molds and shaping said glass into glass gobs while causing glass to float by ejecting gas from the shaping molds and applying gas pressure,
the apparatus comprising a plurality of shaping molds, a gas supply mechanism for supplying said gas and a gas flow passage for supplying gas from the gas supply mechanism to the shaping molds, said gas flow passage having a buffer mechanism for suppressing the variance of gas ejection amounts in shaping molds during shaping of the glass which variance is caused by a pressure variance in gas ejection ports of other shaping molds.

2. The glass gob shaping apparatus of claim 1, wherein the gas flow passage has a manifold portion for distributing gas supplied from one single gas supply mechanism to the shaping molds and as the buffer mechanism, check valves are provided in gas flow passage between said manifold portion and the shaping molds.

3. The glass gob shaping apparatus of claim 1, wherein the gas flow passage has a manifold portion for distributing gas supplied from one single gas supply mechanism to the shaping molds and as the buffer mechanism, gas flow regulating mechanisms are provided in gas flow passage between said manifold portion and the shaping molds.

4. The glass gob shaping apparatus of claim 2, wherein the shaping molds have gas ejection portions formed of a porous material.

5. The glass gob shaping apparatus of claim 1, wherein the gas flow passage has a manifold portion for distributing gas supplied from one single gas supply mechanism to the shaping molds and a porous material is used as a material constituting gas ejection portions of the shaping molds for the buffer mechanism of said gas flow passage.

6. A glass gob shaping apparatus for supplying a molten glass to shaping molds and shaping said glass into glass gobs while causing glass to float by ejecting gas from the shaping molds and applying gas pressure,
the apparatus comprising a plurality of shaping molds and gas supply mechanisms for supplying said gas, said gas supply mechanisms being independently provided in a manner that one single gas supply mechanism corresponds to one shaping mold.

7. The glass gob shaping apparatus of claim 1, which has a shaping mold transfer mechanism for transferring the plurality of shaping molds in circulation.

8. A process for the production of glass gobs by supplying a molten glass to shaping molds and shaping said glass into glass gobs while causing glass to float by ejecting gas from the shaping molds and applying gas pressure,
the process comprising simultaneously shaping glass into glass gobs above a plurality of the shaping molds while a gas supply source for supplying said gas is used in common and return flows of the gas are suppressed between a gas manifold portion existing between said gas supply source and the shaping molds and the shaping molds.

9. A process for the production of glass gobs by supplying a molten glass to shaping molds and shaping said glass into glass gobs while causing glass to float by ejecting gas from the shaping molds and applying gas pressure,
the process comprising simultaneously shaping glass into glass gobs above a plurality of the shaping molds while a gas supply source for supplying said gas is used in common and gas flow rates are adjusted between a gas manifold portion existing between said gas supply source and the shaping molds and the shaping molds.

10. A process for the production of glass gobs by supplying a molten glass to shaping molds and shaping said glass into glass gobs while causing glass to float by ejecting gas from the shaping molds and applying gas pressure,
the process comprising supplying a gas to each shaping mold from a common gas supply source through branched gas flow passages to eject gas from gas ejection portions formed of a porous material in the shaping molds and concurrently shaping glass into the glass gobs above a plurality of the shaping molds.

11. A process for the production of glass gobs by supplying a molten glass to shaping molds and shaping said glass into glass gobs while causing glass to float by ejecting gas from the shaping molds and applying gas pressure,
the process comprising shaping glass into glass gobs above a plurality of the shaping molds while the gas is supplied to the plurality of the shaping molds from independent gas supply sources.

12. A process for the production of an optical element, which comprises heating a glass gob shaped with the apparatus recited in claim 1 or a glass gob produced by supplying a molten glass to shaping molds and shaping said glass into glass gobs while causing glass to float by ejecting gas from the shaping molds and applying gas pressure,
the process comprising simultaneously shaping glass into glass gobs above a plurality of the shaping molds while a gas supply source for supplying said gas is used in common and return flows of the gas are suppressed between a gas manifold portion existing between said gas supply source and the shaping molds and the shaping molds and precision press-molding the glass gob.
